(19) United States
(12) Patent Application Publication
(10) Pub. No.: US 2012/0128936 A1
(43) Pub. Date: May 24, 2012

(54) GLASS OPTICAL ELEMENT AND METHOD FOR MANUFACTURING THE SAME

(76) Inventors: Ryosuke Imajima, Osaka (JP); Toshiya Tomisaka, Osaka (JP)

(21) Appl. No.: 13/288,363

(22) Filed: Nov. 3, 2011

(30) Foreign Application Priority Data
Nov. 19, 2010 (JP) 2010-258761

(51) Int. Cl. B32B 3/30; C03B 11/08

(52) U.S. Cl. 428/156; 65/66

(57) ABSTRACT

A method for manufacturing a glass optical element includes the steps of: feeding molten glass onto a lower mold part; and compression-molding the molten glass using an upper mold part and the lower mold part. The upper mold part is provided with a recess for forming a positioning protrusion of the glass optical element. A surface of the recess includes a first region where a protective film against the molten glass is formed, and a second region where the protective film is not formed and the upper mold part is exposed. In the step of compression-molding the molten glass, after the molten glass enters the recess, the molten glass is compression-molded in a state where a part of the molten glass and the second region do not contact each other, to thereby form the positioning protrusion of the glass optical element.

This application is based on Japanese Patent Application No. 2010-258761 filed with the Japan Patent Office on Nov. 19, 2010, the entire content of which is hereby incorporated by reference.

### BACKGROUND OF THE INVENTION

1. Field of the Invention

The present invention relates to a glass optical element and a method for manufacturing the same, and particularly to a glass optical element having a protrusion formed for the sake of positioning and a method for manufacturing the glass optical element.

2. Description of the Related Art

A glass optical element is manufactured by compression-molding of molten glass in a mold (an upper mold part and a lower mold part). Generally, on the molding surface of the mold, a protective film against the molten glass is formed in advance (see U.S. Pat. No. 7,713,630, U.S. Patent Application Publication No. 2006/0130522, Japanese Laid-Open Patent Publication No. 2002-255568, and U.S. Pat. No. 5,964,916).

Referring to FIGS. 20 and 21, a description will be given of a method for manufacturing a common glass optical element using an upper mold part 110 and a lower mold part 120. FIG. 20 is a cross section showing one of the steps of the method for manufacturing a common glass optical element. FIG. 21 is an enlarged cross section showing the region enclosed by a line XXI in FIG. 20.

As shown in FIG. 20, upper mold part 110 has a flat lower end face 111, a spherically protruded molding face 112, and recesses 113 that are recessed intermittently along the perimeter of molding face 112. On respective surfaces of lower end face 111, molding face 112, and recess 113, a protective film 115 (see FIG. 21) against molten glass 141 is formed in advance. Recess 113 is used for forming a positioning protrusion of the glass optical element. This protrusion is used when the glass optical element is to be attached to a substrate or the like.

Lower mold part 120 has a flat upper end face 121 and a spherically recessed molding face 122. On respective surfaces of upper end face 121 and molding face 122, a protective film 125 (see FIG. 21) against molten glass 141 is also formed in advance. After upper mold part 110 and lower mold part 120 are prepared, molten glass 141 is fed onto lower mold part 120. Molten glass 141 is compressed in a high-temperature atmosphere by upper mold part 110 and lower mold part 120 (the state shown in FIG. 20).

As shown in FIG. 21, molten glass 141 wets and spreads in the space between molding face 112 and molding face 122 and also enters recess 113. Heat is removed (dissipated) from molten glass 141 by upper mold part 110 and lower mold part 120. Molten glass 141 hardens to thereby provide a glass optical element 145 having a protrusion 144.

### SUMMARY OF THE INVENTION

According to the size and the shape of protrusion 144 to be formed on glass optical element 145, the size and the shape of recess 113 are set. In the case where the opening of recess 113 is small while the depth of recess 113 is large (in the case where the aspect ratio is high), it is difficult to form protective film 115 on the entire surface of recess 113. As shown in FIG. 21, along the surface of recess 113, a region 113R1 where protective film 115 is formed and a region 113R2 where protective film 115 is not formed and the bare surface of upper mold part 110 is directly exposed are formed.

When molten glass 141 is compressed by upper mold part 110 and lower mold part 120, molten glass 141 is pressed against region 113R2. As molten glass 141 hardens, molten glass 141 is fused to region 113R2. Oxidization of region 113R2 is promoted, and a mold release failure or the like is likely to occur in region 113R2. Degradation of upper mold part 110 originates from region 113R2, the useful life of upper mold part 110 is shortened, and the productivity of the glass optical elements is deteriorated. This occurs as well in the case where a recess which is used for forming a positioning protrusion is provided in the lower mold part.

An object of the present invention is therefore to provide a glass optical element and a method for manufacturing the glass optical element with which the productivity of the glass optical elements can be improved, even if there is a region where no protective film is formed in the recess of the mold, by suppressing oxidation in this region.

A method for manufacturing a glass optical element according to the present invention includes the steps of: preparing an upper mold part and a lower mold part; feeding molten glass onto the lower mold part; and compression-molding the molten glass using the upper mold part and the lower mold part. The upper mold part or the lower mold part is provided with a recess for forming a positioning protrusion of the glass optical element. A surface of the recess includes a first region where a protective film against the molten glass is formed, and a second region where the protective film is not formed and the upper mold part or the lower mold part is exposed. In the step of compression-molding the molten glass, after the molten glass enters the recess, the molten glass is compression-molded in a state where a part of the molten glass and the second region do not contact each other, to thereby form the positioning protrusion of the glass optical element.

Preferably, the state where the part of the molten glass and the second region do not contact each other in the step of compression-molding the molten glass is obtained by adjusting a viscosity of the molten glass.

Preferably, the state where the part of the molten glass and the second region do not contact each other in the step of compression-molding the molten glass is obtained by adjusting an amount of compression applied to the molten glass by the upper mold part and the lower mold part.

Preferably, the state where the part of the molten glass and the second region do not contact each other in the step of compression-molding the molten glass is obtained by adjusting a depth of the recess.

Preferably, the upper mold part or the lower mold part is provided with a plurality of the recesses. Preferably, the upper mold part is provided with the recess.

A glass optical element according to the present invention is manufactured by the method for manufacturing a glass optical element according to the present invention.

In accordance with the present invention, even if there is a region where no protective is formed in the recess of the mold, oxidation in this region can be suppressed to obtain a glass optical element and a method for manufacturing the glass optical element with which the productivity of the glass optical elements can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 to 4 are cross sections respectively showing first to fourth steps of a method for manufacturing a glass optical element in a first embodiment.

FIG. 5 is an enlarged cross section of a region enclosed by a line V in FIG. 4.

FIG. 6 is a cross section showing a state before the glass optical element in the first embodiment is attached onto a substrate.

FIG. 7 is a cross section showing a state after the glass optical element in the first embodiment is attached onto the substrate.

FIG. 8 is a cross section showing one of steps of a method for manufacturing a glass optical element in a second embodiment.

FIG. 9 is a cross section showing one of steps of a method for manufacturing a glass optical element in another form of the second embodiment.

FIG. 10 is a cross section showing one of steps of a method for manufacturing a glass optical element in a third embodiment.

FIG. 11 is an enlarged cross section of a region enclosed by a line XI in FIG. 10.

FIG. 12 is a cross section showing one of steps of a method for manufacturing a glass optical element in a fourth embodiment.

FIG. 13 is a cross section showing another one of the steps of the method for manufacturing a glass optical element in the fourth embodiment.

FIG. 14 is a cross section showing one of steps of a method for manufacturing a glass optical element in a fifth embodiment.

FIG. 15 is a cross section showing another one of the steps of the method for manufacturing a glass optical element in the fifth embodiment.

FIG. 16 is a cross section showing an upper mold part, a recess, and a lower mold part used for Experiments 1 to 3 conducted based on the first embodiment.

FIGS. 17 to 19 are diagrams showing set conditions for Experiments 1 to 3 respectively.

FIG. 20 is a cross section showing one of steps of a method for manufacturing a common glass optical element.

FIG. 21 is an enlarged cross section of a region enclosed by a line XXI in FIG. 20.

### DESCRIPTION OF THE PREFERRED EMBODIMENTS

Embodiments and examples each based on the present invention will hereinafter be described with reference to the drawings. In the case where the number, the amount, or the like is mentioned in the description of the embodiments and examples each, the scope of the present invention is not necessarily limited to the number, the amount, or the like unless otherwise specified. In the description of the embodiments and examples each, the same components or corresponding components are denoted by the same reference characters, and a description thereof may not be repeated. Unless otherwise limited, it is intended from the beginning that the components illustrated in the embodiments and the components illustrated in the examples may be used in appropriate combination.

### First Embodiment

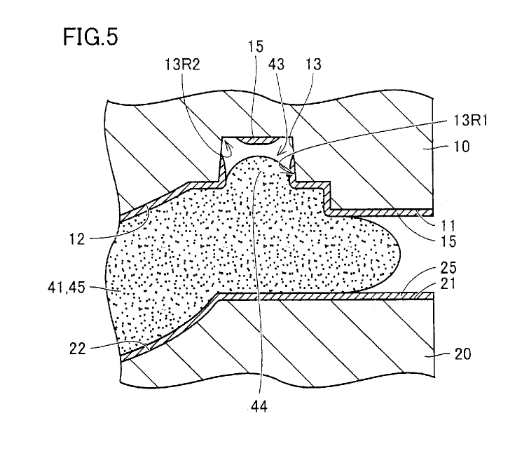

Referring to FIGS. 1 to 5, a description will be given of a method for manufacturing a glass optical element in the present embodiment. This manufacturing method is based on the so-called “drop method” and includes steps ST1 to ST4 (first step to fourth step). FIGS. 1 to 4 are cross sections showing steps ST1 to ST4 respectively. FIG. 5 is an enlarged cross section of the region enclosed by a line V in FIG. 4.

Step ST1

Referring to FIG. 1, an upper mold part 10, a lower mold part 20, a nozzle 30, and molten glass 40 are prepared. Above nozzle 30, a melting furnace (not shown) that holds molten glass 40 is provided. Nozzle 30 is heated by a heater (not shown). A part of the molten glass in the melting furnace is transported through nozzle 30 to the lower end of nozzle 30, and exposed in the form of molten glass 41 from the lower end of nozzle 30. The surface tension keeps molten glass 41 at the lower end of nozzle 30. The viscosity of molten glass 41 is for example from 10¹ to 10¹⁰ poises, and is preferably from 10³ to 10⁷ poises.

Upper mold part 10 has a flat lower end face 11, a spherically protruded molding face 12, and at least one recess 13 recessed along the perimeter of molding face 12. Four recesses 13 can be arranged at 90° intervals for example along the direction of the circumference of molding face 12. Recess 13 is recessed in the shape of a truncated cone. Recess 13 may be recessed in the shape of a cylinder, a prism, or a pyramid. On respective surfaces of lower end face 11, molding face 12, and recess 13, a protective film 15 (see FIG. 5) against molten glass 41 is formed in advance. Protective film 15 is made for example of chromium metal (Cr) or chromium nitride.

In order to form protective film 15, a PVD (Physical Vapor Deposition) method such as evaporative deposition method or sputter deposition method, a CVD (Chemical Vapor Deposition) method, or an ion implantation method for example is used. Details will be described later herein with reference to FIG. 5. Along the surface of recess 13, a region 13R1 where protective film 15 is formed and a region 13R2 where protective film 15 is not formed and the bare surface of upper mold part 10 is directly exposed are present.

Lower mold part 20 is disposed below nozzle 30. Lower mold part 20 has a flat upper end face 21 and a spherically recessed molding face 22. On respective surfaces of upper end face 21 and molding face 22 as well, a protective film 25 (see FIG. 5) against molten glass 41 is formed in advance. In order to form protective film 25, a similar method to the method for forming protective film 15 may be used.

Step ST2

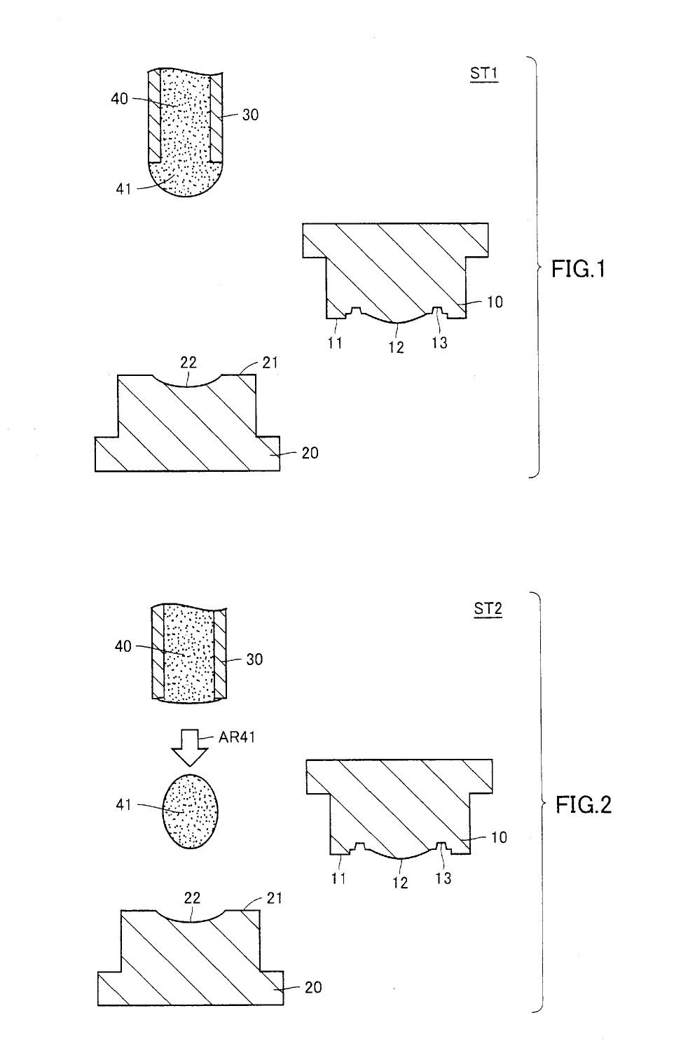

Referring to FIG. 2, nozzle 30 continues being heated to thereby separate molten glass 41 from nozzle 30 as indicated by an arrow AR41. Molten glass 41 is dropped toward lower mold part 20.

Step ST3

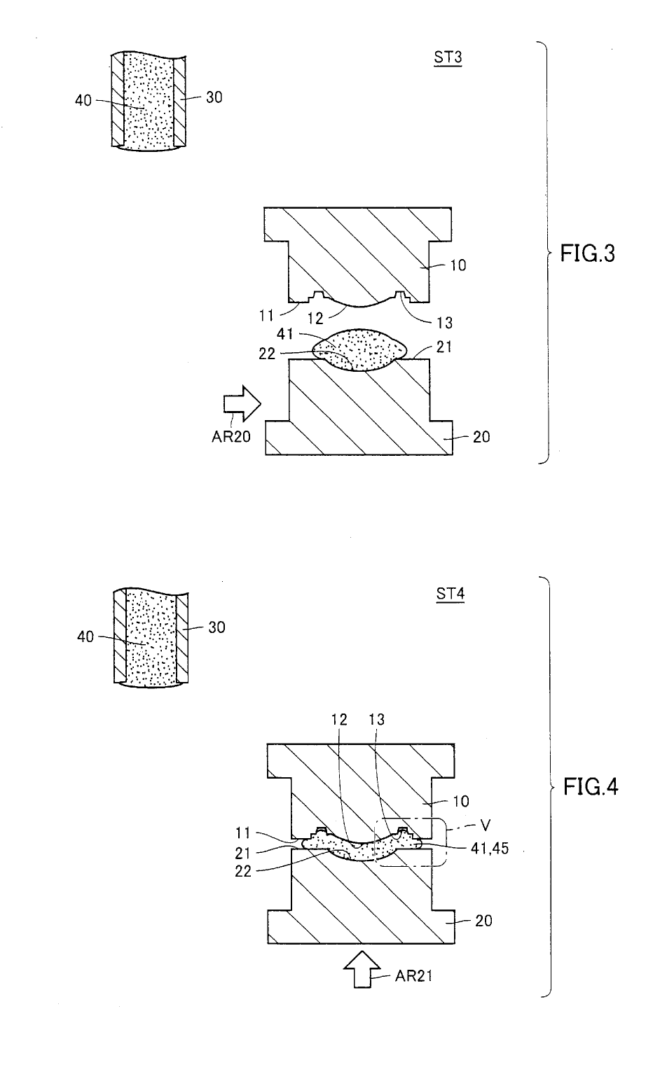

Referring to FIG. 3, molten glass 41 is mainly fed onto upper end face 21 of lower mold part 20. Contact of molten glass 41 with lower mold part 20 causes heat to be removed (dissipated) from molten glass 41, and molten glass 41 starts hardening from its lower side (the side close to lower mold part 20). Molten glass 41 forms a glass gob (a lump of the molten glass). As indicated by an arrow AR20, lower mold part 20 to which molten glass 41 has been fed is moved to below upper mold part 10. Upper mold part 10 may be moved to above lower mold part 20.

Step ST4

Referring to FIG. 4, after a predetermined time has passed from the time when molten glass 41 was fed onto upper end face 21 of lower mold part 20, lower mold part 20 is moved upward as indicated by an arrow AR21. Upper mold part 10 may be moved downward. The surface of molten glass 41 is brought into contact with molding face 12 of upper mold part 10.

Molten glass 41 is compressed in a high-temperature atmosphere by molding face 12 of upper mold part 10 and molding face 22 of lower mold part 20. As means for moving lower mold part 20 (or upper mold part 10) for the purpose of compressing molten glass 41, an air cylinder, a hydraulic cylinder, or an electrical cylinder using a servo motor for example may be used.

As shown in FIG. 5, molten glass 41 wets and spreads in the space between molding face 12 and molding face 22 and also enters recess 13. Along the surface of recess 13, region 13R1 (first region) where protective film 15 is formed and region 13R2 where protective film 15 is not formed and the bare surface of upper mold part 10 is directly exposed are present. Region 13R2 is likely to be formed in the case where the end-to-end diameter of the opening of recess 13 is 4 mm or less, the depth of recess 13 is 0.4 mm or more, and the aspect ratio (depth of recess 13/end-to-end diameter of the opening of recess 13) is 0.5 or more.

In the present embodiment, after molten glass 41 enters recess 13, molten glass 41 is compressed in the state where molten glass 41 and region 13R2 do not contact each other. This state can be obtained by adjusting the viscosity of molten glass 41 to an optimum value. This state can also be obtained by adjusting the amount of compression applied by upper mold part 10 and lower mold part 20 to molten glass 41 to an optimum value. Further, this state can be obtained by adjusting the depth of recess 13 to an optimum value.

After molten glass 41 enters recess 13, molten glass 41 and region 13R2 do not contact each other and accordingly a free-form surface 43 is formed on the top end of molten glass 41 (the part to be formed into a protrusion 44). While the state where free-form surface 43 is formed is maintained, heat is removed (dissipated) from molten glass 41 by upper mold part 10 and lower mold part 20. Molten glass 41 thus hardens to thereby provide glass optical element 45 having protrusion 44.

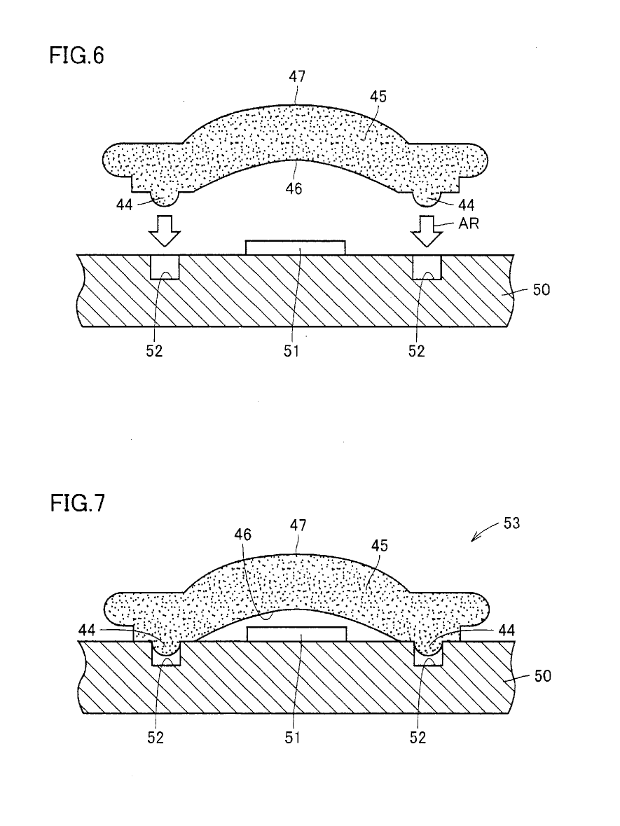

Referring to FIG. 6, glass optical element 45 can for example be attached onto a substrate 50. In substrate 50, a positioning recess 52 is provided. The number and respective positions of recesses 52 correspond to the number and respective positions of protrusions 44 of glass optical element 45. On substrate 50, a light emitting device 51 such as LED (Light Emitting Diode) is mounted.

As indicated by an arrow AR, protrusion 44 is fit in recess 52. Glass optical element 45 is secured to substrate 50 with an adhesive (not shown) or the like. Since glass optical element 45 has protrusion 44, glass optical element 45 can be attached easily to substrate 50 in the state of being positioned with respect to substrate 50.

Referring to FIG. 7, glass optical element 45 is secured to substrate 50 to thereby provide a light emitting apparatus 53. Light emitted from light emitting device 51 propagates from an optical surface 46 toward optical surface 47 through glass optical element 45. In this case, glass optical element 45 can perform the function of a diffusing lens or a condenser lens.

Functions and Effects

Referring again to FIG. 5, after molten glass 41 enters recess 13, molten glass 41 is compression-molded in the state where molten glass 41 and region 13R2 in which protective film 15 is not formed do not contact each other. When molten glass 41 hardens, molten glass 41 does not contact region 13R2. Molten glass 41 is not fused to region 13R2, and free-form surface 43 is formed on the top end of molten glass 41 (the part to be formed into protrusion 44)

Oxidation of region 13R2 is suppressed, and a mold release failure or the like does not occur in region 13R2. The useful lifetime of upper mold part 10 is extended, and the productivity of glass optical element 45 is improved. Glass optical element 45 thus obtained can be used for light emitting apparatus 53 (see FIG. 7), and can also be used as any of various lenses such as a lens adapted to a digital camera, an optical pickup lens adapted to a DVD (Digital Versatile Disc) or the like, a camera lens adapted to a mobile phone, or a coupling lens adapted to optical communication, or any of various mirrors.

In the present embodiment, upper mold part 10 is provided with recess 13 for forming protrusion 44. Molten glass 41 is fed onto lower mold part 20, and the surface of molten glass 41 gradually hardens. After a predetermined time has passed, upper mold part 10 and molten glass 41 are brought into contact with each other. At an appropriate contact time (timing), upper mold part 10 and molten glass 41 may be brought into contact with each other. After molten glass 41 enters recess 13, the state where molten glass 41 does not contact region 13R2 in which protective film 15 is not formed can more reliably be obtained.

### Second Embodiment

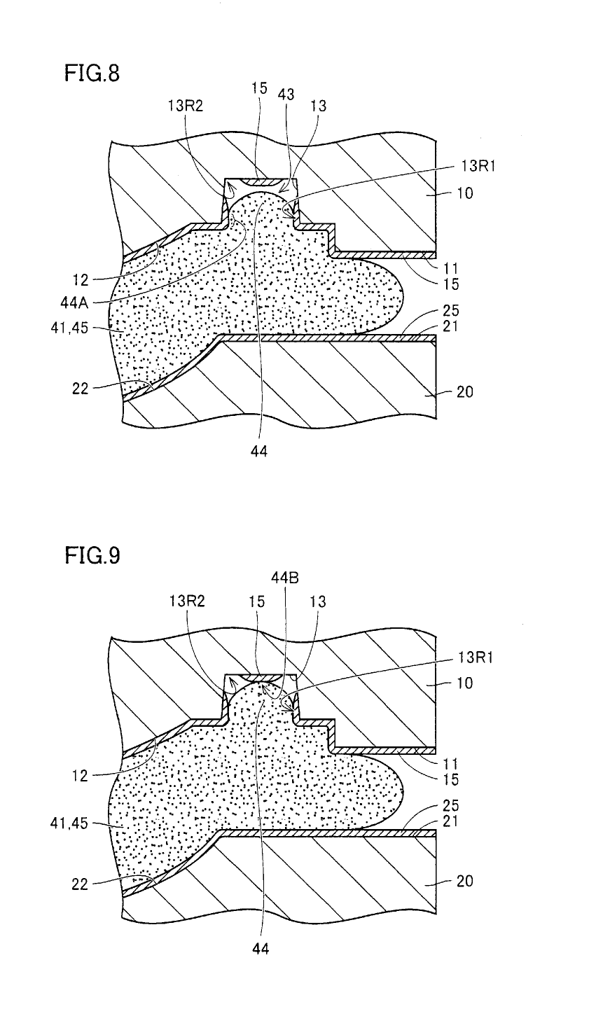

Referring to FIG. 8, a description will be given of a method for manufacturing a glass optical element in the present embodiment. Differences between the present embodiment and the above-described first embodiment will be described here. FIG. 8 is a cross section showing a step (corresponding to step ST4 in the above-described first embodiment) of the steps of the method for manufacturing a glass optical element in the present embodiment.

In the above-described first embodiment, after molten glass 41 (see FIG. 5) enters recess 13, free-form surface 43 is formed that originates from an area in the vicinity of the opening end of recess 13. Protrusion 44 formed by recess 13 is substantially hemispherical in shape.

As shown in FIG. 8, molten glass 41 may enter recess 13 to a greater depth than the above-described first embodiment. In this case, along the outer periphery of protrusion 44, protrusion 44 and protective film 15 contact each other to form an annular sidewall 44A. By means of sidewall 44A, glass optical element 45 can be positioned more reliably (with less backlash) with respect to a substrate or the like.

In another form as shown in FIG. 9, a top end 44B of free-form surface 43 may contact protective film 15 formed on the bottom of recess 13. Molten glass 41 enters recess 13 to a greater depth, and thus protrusion 44 can more effectively perform the positioning function of protrusion 44.

As molten glass 41 enters recess 13 to a greater depth, molten glass 41 and region 13R2 are more likely to be brought into contact with each other. Although the state where the whole of molten glass 41 is in non-contact with region 13R2 (the state shown in FIG. 9) is most desirable, a part of molten glass 41 may be in non-contact with region 13R2. In an area where a part of molten glass 41 does not contact region 13R2, free-form surface 43 is formed. As compared with the conventional case where the whole of molten glass 41 and region 13R2 contact each other (the state shown in FIG. 21), oxidation or the like is suppressed in the area where a part of molten glass 41 and region 13R2 do not contact each other.

### Third Embodiment

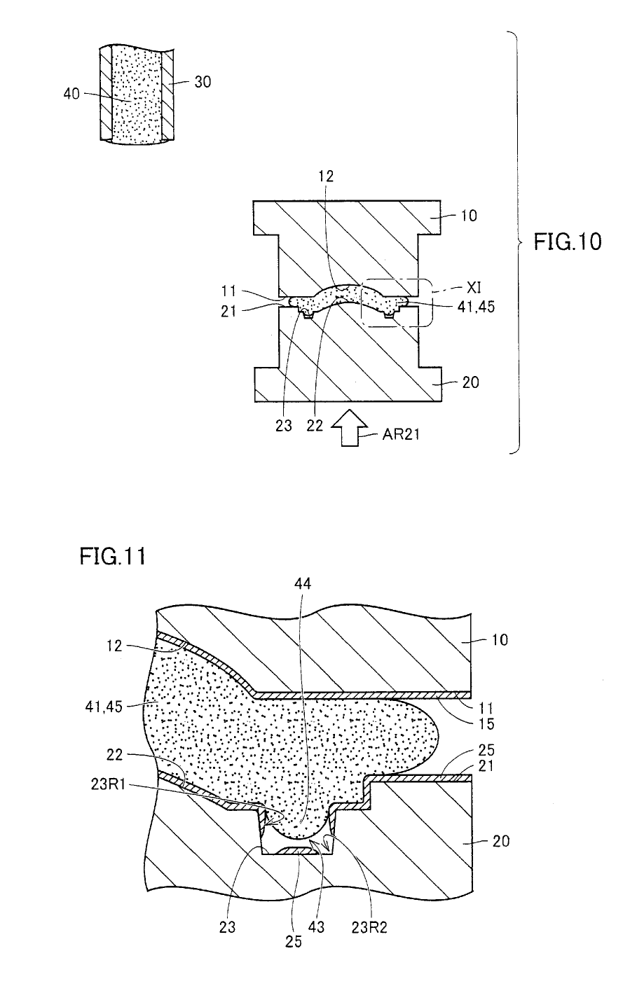

Referring to FIGS. 10 and 11, a method for manufacturing a glass optical element in the present embodiment will be described. Differences between the present embodiment and the above-described first embodiment will be described here. FIG. 10 is a cross section showing a step (corresponding to step ST4 in the above-described first embodiment) of the steps of the method for manufacturing a glass optical element in the present embodiment. FIG. 11 is an enlarged cross section of the region enclosed by a line XI in FIG. 10.

As shown in FIGS. 10 and 11, in the present embodiment, lower mold part 20 is provided with a recess 23. Along the surface of recess 23, a region 23R1 (first region) and a region 23R2 (second region) are present. In region 23R1, protective film 25 is formed like region 13R1 (see FIG. 5) in the above-described first embodiment. In region 23R2, protective film 25 is not formed and the bare surface of lower mold part 20 is directly exposed like region 13R2 (see FIG. 5) in the above-described first embodiment.

In the present embodiment as well, molten glass 41 enters recess 23 and thereafter molten glass 41 is compressed in the state where molten glass 41 and region 23R2 do not contact each other. When molten glass 41 hardens, molten glass 41 does not contact region 23R2. Molten glass 41 is not fused to region 23R2, and free-form surface 43 is formed on the top end of molten glass 41 (the part to be formed into protrusion 44). Oxidation of region 23R2 is suppressed, and a mold release failure or the like does not occur in region 23R2. Accordingly, the useful lifetime of lower mold part 20 is extended, and the productivity of glass optical element 45 is improved.

### Fourth Embodiment

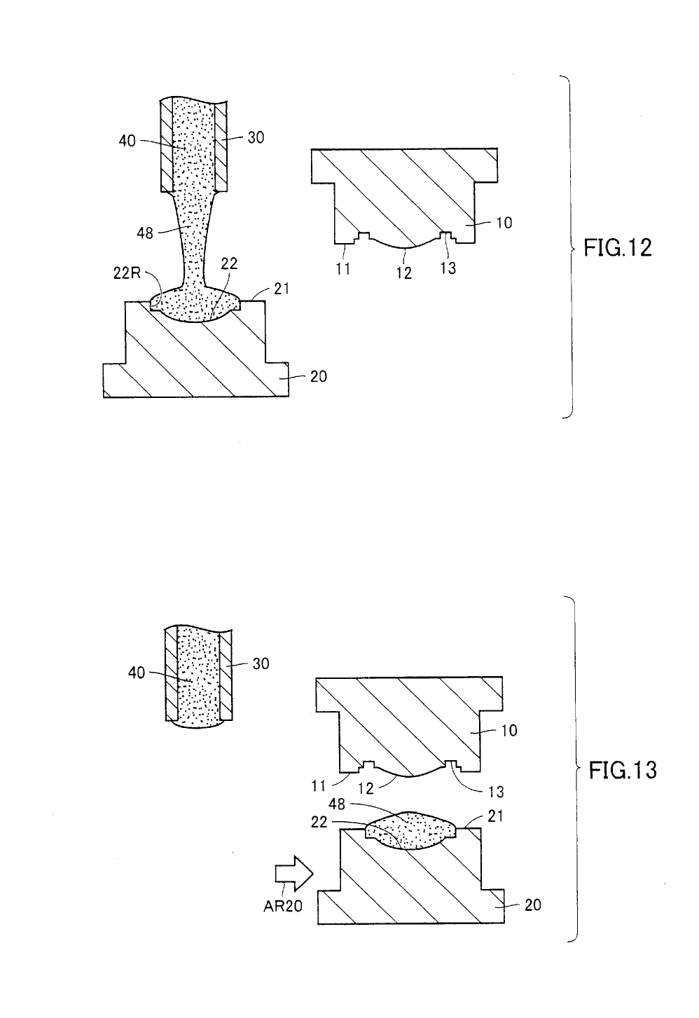

Referring to FIGS. 12 and 13, a description will be given of a method for manufacturing a glass optical element in the present embodiment. Differences between the present embodiment and the above-described first embodiment will be described here. FIG. 12 is a cross section showing a step (corresponding to step ST2 in the above-described first embodiment) of the steps of the method for manufacturing a glass optical element in the present embodiment. FIG. 13 is a cross section showing another step (corresponding to step ST3 in the above-described first embodiment) of the steps of the method for manufacturing a glass optical element in the present embodiment.

In the above-described first embodiment, molten glass 41 (see FIG. 2) is separated from nozzle 30 by continuous heating of nozzle 30. Molten glass 41 is dropped toward lower mold part 20 and accordingly molten glass 41 is fed onto lower mold part 20 (so-called drop method).

As shown in FIG. 12, in the present embodiment, molten glass 48 linearly falls as if it hangs from molten glass 40. As molten glass 48 falls, molten glass 48 is fed onto lower mold part 20. Lower mold part 20 is provided with a sidewall 22R for restricting extension of molten glass 48. Molten glass 48 is fed onto the surface of molding face 22. Contact between molten glass 48 and lower mold part 20 causes heat to be removed (dissipated) from molten glass 48, and molten glass 48 starts hardening from its lower side (the side close to lower mold part 20).

Referring to FIG. 13, as indicated by an arrow AR20, lower mold part 20 fed with molten glass 48 is moved to below upper mold part 10. Upper mold part 10 may be moved to above lower mold part 20. Molten glass 48 is compression-molded in a similar manner to the above-described first embodiment. The method for manufacturing a glass optical element in the present embodiment can also provide the functions and effects similar to the above-described first embodiment.

### Fifth Embodiment

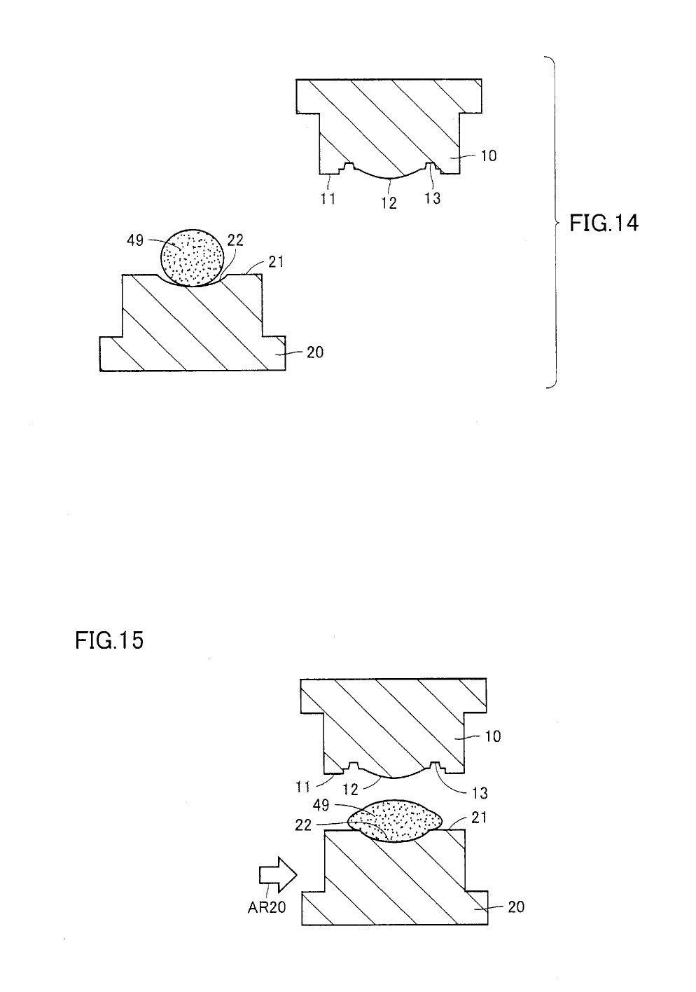

Referring to FIGS. 14 and 15, a description will be given of a method for manufacturing a glass optical element in the present embodiment. This manufacturing method is based on the so-called re-heating method (or reheat press method). Here, differences between the present embodiment and the above-described first embodiment will be described. FIG. 14 is a cross section showing a step (corresponding to step ST2 in the above-described first embodiment) of the steps of the method for manufacturing a glass optical element in the present embodiment. FIG. 15 is a cross section showing another step (corresponding to step ST3 in the above-described first embodiment) of the steps of the method for manufacturing a glass optical element in the present embodiment.

In the above-described first embodiment, molten glass 41 (see FIG. 2) is separated from nozzle 30 by continuous heating of nozzle 30. Molten glass 41 is dropped toward lower mold part 20 and thus molten glass 41 is fed onto lower mold part 20 (so-called drop method).

As shown in FIG. 14, in the present embodiment, a glass preform 49 having a predetermined mass and a predetermined shape is prepared. Glass preform 49 can be manufactured by machining of glass such as cutting or polishing. Glass preform 49 is placed on molding face 22 of lower mold part 20. Glass preform 49 is heated by lower mold part 20. This heating causes glass preform 49 to be melted from its lower side (the side close to lower mold part 20), and fed in the form of molten glass on molding face 22 of lower mold part 20.

Referring to FIG. 15, as indicated by an arrow AR20, lower mold part 20 fed with glass preform 49 which has been changed into the molten glass is moved to below upper mold part 10. Upper mold part 10 may be moved to above lower mold part 20. Glass preform 49 which has been changed into the molten glass is compression-molded in a similar manner to the above-described first embodiment. The method for manufacturing a glass optical element in the present embodiment can also provide the functions and effects similar to the above-described first embodiment.

Further, in the present embodiment, recess 23 (see FIGS. 10 and 11) for forming protrusion 44 may be provided in lower mold part 20. In contrast to the drop method in the above-described first embodiment and the method in the above-described fourth embodiment, glass preform 49 which changes gradually into the molten glass slowly enters recess 23 provided in lower mold part 20.

At an appropriate time (timing), upper mold part 10 and molten glass 41 are brought into contact with each other. The state where glass preform 49, which has been changed into the molten glass, and protective film 25 do not contact each other (see FIG. 11) can easily be obtained.

### EXAMPLES AND COMPARATIVE EXAMPLES

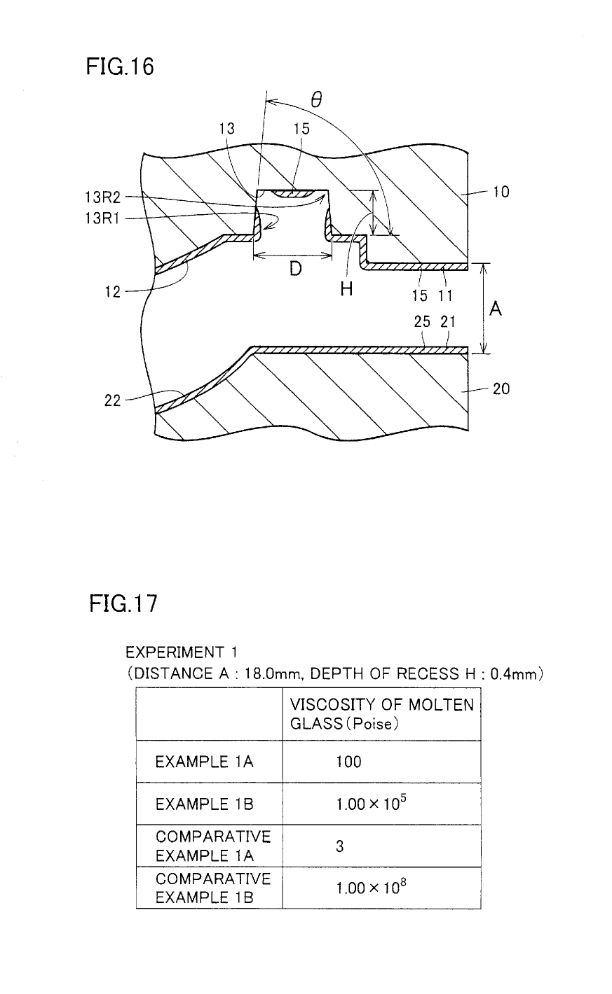

A description will be given of Experiments 1 to 3 conducted based on the method for manufacturing a glass optical element in the above-described first embodiment as well as the results of the experiments. Referring to FIG. 16, in the experiments, recess 13 is provided in upper mold part 10. Recess 13 is recessed in the shape of a truncated cone. An end-to-end diameter D of the opening of recess 13 is set to 2 mm. An angle of inclination θ of the sidewall of recess 13 is set to 80°.

Experiment 1

Referring to FIG. 17, in Experiment 1, a distance A between lower end face 11 of upper mold part 10 and upper end face 21 of lower mold part 20 when molten glass (not shown) was compressed was set to 18.0 mm. A depth H of recess 13 was set to 0.4 mm. Under these set conditions, the following four different molten glasses were prepared.

In Example 1A, a molten glass having a viscosity of 100 poises was prepared. Upper mold part 10 and lower mold part 20 were used to compress this molten glass. After the molten glass entered recess 13, the state where molten glass 41 and region 13R2 did not contact each other was obtained.

In Example 1B, a molten glass having a viscosity of 1.00×10⁵ poises was prepared. Upper mold part 10 and lower mold part 20 were used to compress this molten glass. After the molten glass entered recess 13, the state where molten glass 41 and region 13R2 did not contact each other was obtained.

In contrast, in Comparative Example 1A, a molten glass having a viscosity of 3 poises was prepared. Upper mold part 10 and lower mold part 20 were used to compress this molten glass. After the molten glass entered recess 13, molten glass 41 wetted and spread to substantially fill the whole inside of recess 13. Molten glass 41 contacted region 13R2, and molten glass 41 was completely transferred to recess 13.

In Comparative Example 1B, a molten glass having a viscosity of 1.00×10⁸ poises was prepared. Upper mold part 10 and lower mold part 20 were used to compress this molten glass. The molten glass did not enter recess 13, and thus no positioning protrusion was formed.

It can be seen from the results of Experiment 1 that the viscosity of the molten glass can be adjusted to an optimum value to thereby obtain the state where the molten glass and region 13R2 do not contact each other after the molten glass is compressed to enter recess 13.

Experiment 2

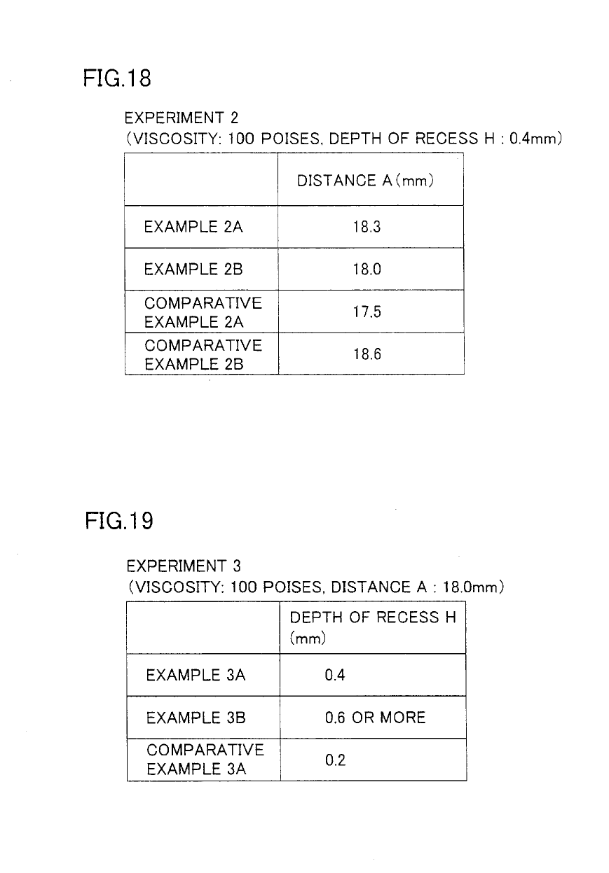

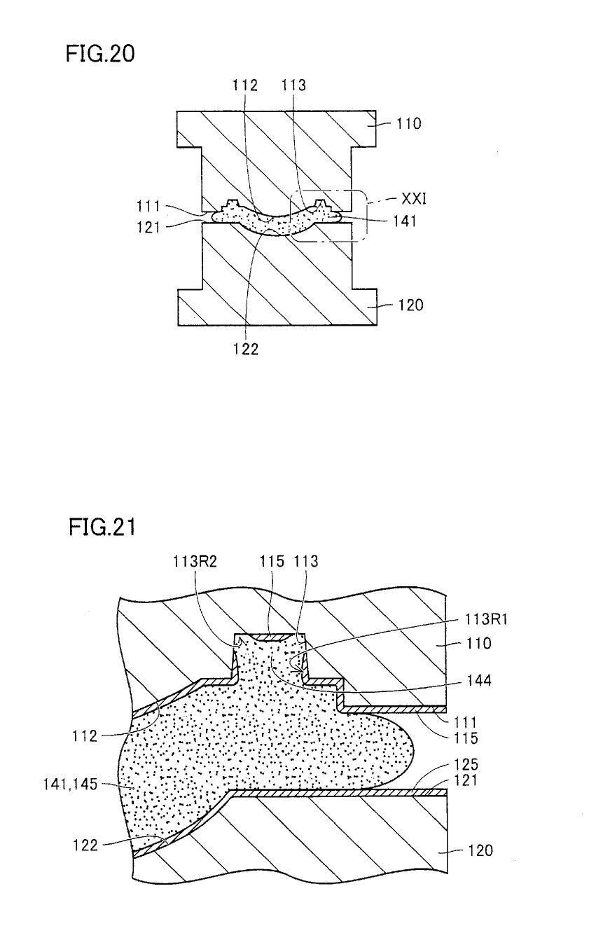

Referring to FIG. 18, in Experiment 2, the viscosity of the molten glass to be compressed was set to 100 poises. Depth H of recess 13 was set to 0.4 mm. Under these set conditions, distance A between lower end face 11 of upper mold part 10 and upper end face 21 of lower mold part 20 when the molten glass was compressed was set to the following four different distances.

In Example 2A, distance A was set to 18.3 mm. Upper mold part 10 and lower mold part 20 were used to compress the molten glass. After the molten glass entered recess 13, the state where molten glass 41 and region 13R2 did not contact each other was obtained.

In Example 2B, distance A was set to 18.0 mm. Upper mold part 10 and lower mold part 20 were used to compress the molten glass. After the molten glass entered recess 13, the state where molten glass 41 and region 13R2 did not contact each other was obtained.

In Comparative Example 2A, distance A was set to 17.5 mm. Upper mold part 10 and lower mold part 20 were used to compress the molten glass. After the molten glass entered recess 13, molten glass 41 wetted and spread to substantially fill the whole inside of recess 13. Molten glass 41 contacted region 13R2, and molten glass 41 was completely transferred to recess 13.

In Comparative Example 2B, distance A was set to 18.6 mm. Upper mold part 10 and lower mold part 20 were used to compress the molten glass. The molten glass did not enter recess 13, and no positioning protrusion was formed.

It can be seen from the results of Experiment 2 that distance A (namely the amount of compression applied to the molten glass) between lower end face 11 of upper mold part 10 and upper end face 21 of lower mold part 20 when the molten glass is compressed can be adjusted to an optimum value to thereby obtain the state where the molten glass and region 13R2 do not contact each other after the molten glass is compressed to enter recess 13.

Experiment 3

Referring to FIG. 19, in Experiment 3, the viscosity of the molten glass to be compressed was set to 100 poises. Distance A between lower end face 11 of upper mold part 10 and upper end face 21 of lower mold part 20 when the molten glass was compressed was set to 18.0 mm. Under these set conditions, depth H of recess 13 was set to the following three different depths.

In Example 3A, depth H of recess 13 was set to 0.4 mm. Upper mold part 10 and lower mold part 20 were used to compress the molten glass. After the molten glass entered recess 13, the state where molten glass 41 and region 13R2 did not contact each other was obtained.

In Example 3B, depth H of recess 13 was set to 0.6 mm or more. Upper mold part 10 and lower mold part 20 were used to compress the molten glass. After the molten glass entered recess 13, the state where molten glass 41 and region 13R2 did not contact each other was obtained.

In Comparative Example 3A, depth H of recess 13 was set to 0.2 mm. Upper mold part 10 and lower mold part 20 were used to compress the molten glass. After the molten glass entered recess 13, molten glass 41 wetted and spread to substantially fill the whole inside of recess 13. Molten glass 41 contacted region 13R2, and molten glass 41 was completely transferred to recess 13.

It can be seen from the results of Experiment 3 that depth H of recess 13 can be adjusted to an optimum value to thereby obtain the state where the molten glass and region 13R2 do not contact each other after the molten glass is compressed to enter recess 13.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method for manufacturing a glass optical element comprising the steps of:
preparing an upper mold part and a lower mold part;
feeding molten glass onto said lower mold part; and
compression-molding said molten glass using said upper mold part and said lower mold part,
said upper mold part or said lower mold part being provided with a recess for forming a positioning protrusion of said glass optical element,
a surface of said recess including a first region where a protective film against said molten glass is formed, and a second region where said protective film is not formed and said upper mold part or said lower mold part is exposed, and
in said step of compression-molding said molten glass, after said molten glass enters said recess, said molten glass being compression-molded in a state where a part of said molten glass and said second region do not contact each other, to thereby form said positioning protrusion of said glass optical element.

2. The method for manufacturing a glass optical element according to claim 1, wherein said state where said part of said molten glass and said second region do not contact each other in said step of compression-molding said molten glass is obtained by adjusting a viscosity of said molten glass.

3. The method for manufacturing a glass optical element according to claim 1, wherein said state where said part of said molten glass and said second region do not contact each other in said step of compression-molding said molten glass is obtained by adjusting an amount of compression applied to said molten glass by said upper mold part and said lower mold part.

4. The method for manufacturing a glass optical element according to claim 1, wherein said state where said part of said molten glass and said second region do not contact each other in said step of compression-molding said molten glass is obtained by adjusting a depth of said recess.

5. The method for manufacturing a glass optical element according to claim 1, wherein said upper mold part or said lower mold part is provided with a plurality of said recesses.

6. The method for manufacturing a glass optical element according to claim 1, wherein said upper mold part is provided with said recess.

7. A glass optical element manufactured by the method for manufacturing a glass optical element as recited in claim 1.
